(19) United States
(12) Patent Application Publication
(10) Pub. No.: US 2025/0131514 A1
(43) Pub. Date: Apr. 24, 2025

(54) HUMAN RELATIONSHIP PROPOSING SYSTEM, METHOD, AND PROGRAM

(71) Applicant: NIPPON TELEFGRAPH AND TELEPHONE CORPORATION, Tokyo (JP)

(72) Inventors: Mariko NAKAMURA, Musashino-shi, Tokyo (JP); Atsushi FUKAYAMA, Musashino-shi, Tokyo (JP); Fumiya AKASAKA, Musashino-shi, Tokyo (JP)

(21) Appl. No.: 18/570,577

(22) PCT Filed: Jun. 18, 2021
(86) PCT No.: PCT/JP2021/023277

§ 371 Date: Dec. 14, 2023

(51) Int. Cl. H04L 67/52; G06Q 50/00; H04L 51/52; H04L 67/306

(52) U.S. Cl. CPC G06Q 50/01

(57) ABSTRACT

A connection providing system for providing information for promoting connection between a plurality of users via a communication line includes a designation unit for designating a place where each of the plurality of users wants to obtain a connection with another user, a determination unit that determines, when information indicating a current location is transmitted from a user terminal operated by any one of the plurality of users, whether the current location matches with a location designated by any one of the plurality of users, and a notification unit that notifies, in a case where affirmative determination is made by the determination unit, the user terminal of the user who has designated the matching place of the current location and information on the user who operates the user terminal that has transmitted the information indicating the current location.

### TECHNICAL FIELD

Embodiments of the present invention include a connection providing system, a method, and a program for providing information that promotes a connection between individuals, for example, using a social networking service (SNS).

### BACKGROUND ART

In general, people who have few opportunities to be active outside of their homes and workplaces (businesses) due to illness, nursing care, childbirth, retirement, etc., may, if their environment changes completely, experience a break in the human relationships and experiences they have built up in their lives, and the human relationships built in a company will be lost, and if experiences gained so far cannot be utilized, there are many cases of a feeling of separation from society. This can also lead to self-denial and further social isolation. This may further lead to self negation or social isolation.

This kind of self-denial and social isolation is not easy to get out of once fallen into, and as a result of continuing to suffer from loneliness, in the worst cases this has become a serious social problem causing abuse, suicide, and solitary death.

In general, it is thought that a good way to deal with the pain caused by self-denial and social loneliness is to talk and interact with people who are in a similar situation or have similar philosophies.

In the world of social networking services (hereafter abbreviated as “SNSs”), as in PTL 1 and NPL 1 to 5, there are networks based on social relationships (human relationships), which are linked to real individuals by an ID and are connected via ICT (Information and Communication Technology).

Further, according to ICT, it is possible not only to connect with identifiable individuals, but also to connect with unspecified individuals, that is, with an unspecified number of individuals.

However, even if the ICT is used, it is impossible to search for an individual who is in an environment similar to the individual among many and unspecified individuals.

In this way, there is no means for providing a connection with people who have the same worries, want to do the same, or have similar philosophies from an unspecified number of individuals who have not interacted so far, those who are in similar circumstances to themselves.

### CITATION LIST

### Patent Literature

[PTL 1] Japanese Patent No. 5883744

### Non Patent Literature

[NPL 1] Blog https://e-words.jp/w/%E3%83%96%E3%83%AD%E3%82%B0.html (retrieved on May 7, 2021)
[NPL 2] Facebook (registered trademark) https://e-words.jp/w/Facebook.html (retrieved on May 7, 2021)
[NPL 3] Instagram https://e-words.jp/w/Instagram.html (retrieved on May 7, 2021)
[NPL 4] twitter https://about.twitter.com/(retrieved on May 7, 2021)
[NPL 5] twitter https://e-words.jp/w/Twitter.html (retrieved on May 7, 2021)

### SUMMARY OF INVENTION

### Technical Problem

The present invention has been made by paying attention to the above circumstances, and an object of the present invention is to provide a system, a method, and a program for providing information that promotes connections with people who are in the same situation, have the same worries, want to do the same thing, or have similar philosophies from an unspecified number of individuals.

### Solution to Problem

In order to solve the above problem, a first aspect of the present invention is a connection providing system for providing information for promoting connection between a plurality of users via a communication line including a designation unit for designating a place where each of the plurality of users wants to obtain a connection with another user, a designation unit for designating a place where each of the plurality of users wants to obtain a connection with another user, a determination unit that determines, when information indicating a current location is transmitted from a user terminal operated by any one of the plurality of users, whether the current location matches with a location designated by any one of the plurality of users, and a notification unit that notifies, in a case where affirmative determination is made by the determination unit, the user terminal of the user who has designated the matching place of the current location and information on the user who operates the user terminal that has transmitted the information indicating the current location.

### Advantageous Effects of Invention

According to the present invention, it is possible to provide information that promotes connections with people who are in the same situation, have the same worries, want to do the same thing, or have similar philosophies from an unspecified number of individuals.

### BRIEF DESCRIPTION OF DRAWINGS

FIG. 1 is a conceptual diagram illustrating a network environment to which a connection providing system according to an embodiment of the present invention is applied.

FIG. 2 is a block diagram illustrating an electronic circuit configuration example of the connection providing system according to the embodiment of the present invention.

FIG. 3 is a diagram illustrating an operation example of the connection providing system to which a connection providing method according to the embodiment of the present invention is applied.

### DESCRIPTION OF EMBODIMENTS

A connection providing system to which a connection providing method according to an embodiment of the present invention is applied will be described below with reference to the drawings.

In addition, in the following description of the embodiments, the same reference numerals are used to denote the same parts to avoid redundant description.

### (Configuration)

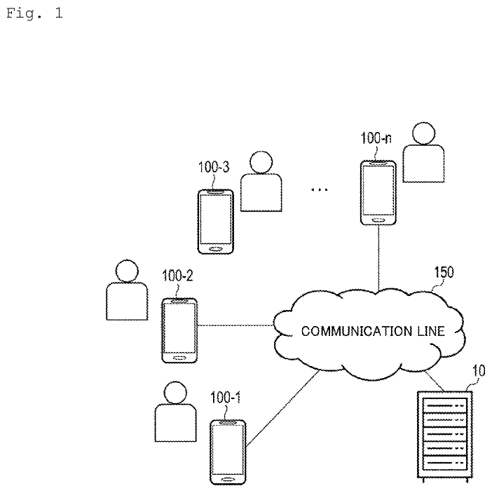

FIG. 1 is a conceptual diagram illustrating a network environment to which a connection providing system according to an embodiment of the present invention is applied.

The connection providing system 10 is a system for providing information for promoting connection between a plurality of users through a communication line 150 such as the Internet, and as illustrated in FIG. 1, communication with a plurality of user terminals 100 can be performed via a communication line 150.

The network environment illustrated in FIG. 1 may include a LAN such as Ethernet (registered trademark), or a WAN to which a plurality of LANs are connected via a public line or a dedicated line. In the case of a LAN, a number of sub-nets are formed through routers as necessary. In the case of a WAN, a firewall or the like for connecting to a public line is appropriately provided, but the illustration and detailed description thereof are omitted here.

The user terminal 100 (for example, user terminals 100-1, 100-2, 100-3, . . . 100-n: n is an integer of 4 or more) is a terminal operated by each user, and may be, for example, a mobile terminal such as a smart phone or a tablet or a stationary PC.

In this specification, a user is, for example, a person who is in a similar situation, has the same troubles, wants to do the same thing, or seeks a connection with a person who has similar philosophies from an unspecified number of individuals.

Although four or more user terminals 100 are illustrated as an example in FIG. 1, when the number of the user terminals 100 is at least two, the present invention is established.

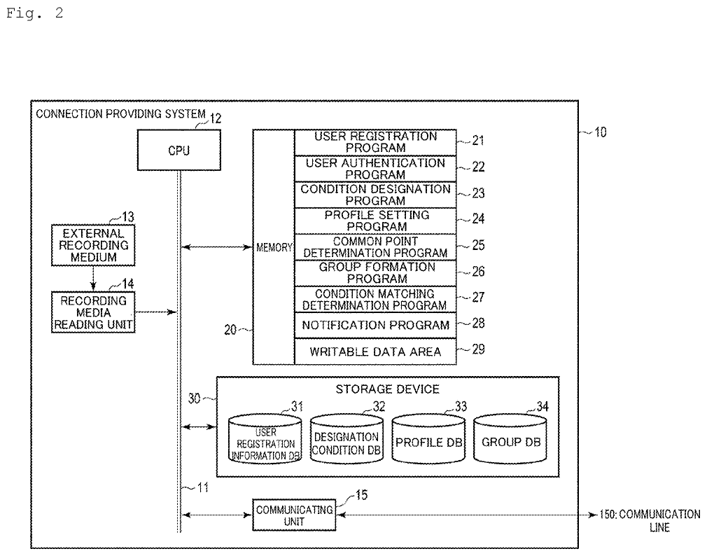

FIG. 2 is a block diagram illustrating an electronic circuit configuration example of the connection providing system according to the embodiment of the present invention.

The connection providing system 10 includes a CPU 12, a recording media reading unit 14, a communication unit 15, a memory 20, and a storage device 30, which are connected to each other through a bus 11.

The memory 20 stores a user registration program 21, a user authentication program 22, a condition designation program 23, a profile setting program 24, a common point determination program 25, a group formation program 26, a condition matching determination program 27, and a notification program 28.

The CPU 12 is a computer, controls the operation of each part of the circuit according to each of programs 21 to 28 stored in the memory 20, and operates as described below in cooperation with software and hardware.

Each of the programs 21 to 28 may be stored in advance in the memory 20 or may be read and stored in the memory 20 from an external recording medium 13 such as a memory card through the recording media reading unit 14. The programs 21 to 28 cannot be rewritten.

The memory 20 secures a writable data area 29 as an area for storing rewritable data in addition to such a user unrewritable area.

The storage device 30 includes, for example, a solid state drive (SSD), a hard disk Drive (HDD), or the like, and stores a user registration information database 31, a designation condition database 32, a profile database 33, and a group database 34.

The communication unit 15 can communicate with a plurality of user terminals 100 operated by each of a plurality of users via a communication line 150.

The user needs to register the user in order to use the connection providing system 10 using this application. In a case where user registration is performed, for example, the user installs a dedicated application provided by the connection providing system 10 in the user terminal 100, the user terminal 100 accesses the connection providing system 10 via the communication line 150 to start the user registration program 21.

In response to this, the user registration program 21 gives the user ID to the user terminal 100 of the access source, and requests the setting of the password PW and the input of a contact address such as an e-mail address.

In response to this, a user inputs a password PW determined by the user himself/herself within a designation condition (for example, within 8 characters including alphanumeric characters) from the user terminal 100. Further, when contact address information such as an e-mail address is input, the user registration program 21 associates the input password PW with the user ID. Further, contact address information is added and written in the user registration information database 31, whereby the user registration is completed.

After completing the user registration, when the user logs in the connection providing system 10 by using, for example, the dedicated application, the user authentication program 22 requests a user to input a user ID and a password PW. On the other hand, when the user inputs the user ID and the password PW from the user terminal 100, the user authentication program 22 confirms whether the set of the input user ID and the password PW is registered in the user registration information database 31. When the information is registered, the log-in is permitted, and when the information is not registered, the log-in is rejected. The user permitted to log in can use the connection providing system 10. On the other hand, the user whose log-in has been rejected cannot use the connection providing system 10. The user authentication program 22 can transmit a message for recommending user registration to the user terminal 100 which has rejected the log-in. In response to this, the user is prompted to execute the above-mentioned user registration.

### (Providing Connection Using Check-In Registration Function)

The user starts the condition designation program 23 in a state where the user logs in the connection providing system 10 from the user terminal 100, for example, using the dedicated application and can set a condition for obtaining a connection with another user. For example, a park, a building, a place and an area such as a station and a restaurant, a specific time zone, a hobby, and a problem, can be arbitrarily set for the condition (hereinafter referred to as “designation condition S”). The designation condition S is written in the designation condition database 32 by the condition designation program 23 in association with a user ID of a user being a setting person.

A check-in registration function for transmitting the current location, the arrival time at the current location, and the user ID to the connection providing system 10 is provided to the user terminal 100 in which the dedicated application is installed.

Therefore, in a case where a user (for example, a first user) arrives at a certain place due to a walk, a travel or the like, by the check-in registration function, the user terminal 100-1 operated by the user, transmits a current location D (for example, OX park), the arrival time at the current location D, and the user ID, to the connection providing system 10.

The transmitted current location D (for example, OX park), the arrival time, and the user ID are received by a communication unit 15 via the communication line 150, and output from the communication unit 15 to the memory 20.

The condition matching determination program 27 refers to the designation condition database 32 to determine whether the current location D output from the communication unit 15 is included in a designation condition S set by a user other than the first user.

In a case where an affirmative determination is made by the condition matching determination program 27, that is, when the OX park which is the current location D output from the communication unit 15 is included in a designation condition S set by another user, and the notification program 28 notifies the user terminal 100-2 of another user (for example, a second user) that is a setting person of the designation condition S including the OX park of information on the current location D (OX park) and the first user operating the user terminal 100-1 of a transmission source.

The information on the user is, for example, the designation condition S or a contact address set by the user. In a case of transmitting the designation condition S and contact address information of a user of a transmission source of the current location D, the condition matching determination program 27 acquires the designation condition S set by the user from the designation condition database 32, acquires the contact destination information of the user from the user registration information database 31, and outputs the information to the

In response to this, the notification program 28 notifies the user terminal 100-2 of the second user who has set the designation condition S including the current location D of the designation condition S and the contact address information of the first user who has transmitted the current location D.

### (Providing Connection Using Profile Function)

The user starts the profile setting program 24 in a state where the user logs in the connection providing system 10 from the user terminal 100, for example, using the dedicated application, and can set the profile P him/herself.

In the connection providing system 10, the profile P is used as a condition for determining the presence or absence of relevance and commonality with other users.

Users can enter one or more arbitrary items such as age, hobbies, marital status, whether or not they have children and their ages, concerns, whether or not parents live together, living area, nearest station, favorite places, problems, or the like, as profile P. For example, when seeking connections with other users who have common concerns, the profile P may include specific concerns (childcare, nursing care, human relations at the company, or the like), when seeking connections with other users who have common hobbies, the profile P may include specific hobbies (walking, jogging, or the like), and when seeking connections with other users in the vicinity, the profile P may include specific places (nearest station, restaurants, public facilities, parks, or the like) that the user frequently visits. On the other hand, the contents which are not desired to be connected may not be included in the profile P.

In this way, in the connection providing system 10, the profile P is not used as personal information such as so-called name and address, but used as information to be a trigger for obtaining a connection with another user.

The profile setting program 24 sets the profile P of the user by writing the input profile P in a profile database 33 in association with the user ID.

The common point determination program 25 refers to the profile P of each user written in the profile database 33, and determines a user having many common points in the content of the profile P. As mentioned above, the profile P can include one or more items. The common point determination program 25 can determine a user whose profile P includes common information in a predetermined percentage or more of the items included in the profile as a user (for example, a first user, a second user, and a third user) with many common points in the contents of the profile P.

The group formation program 26 forms a group G composed of each user whose contents of the profile P are determined to have many common points by the common point determination program 25. Then, a group ID unique to the group is given to the formed group G, and the group ID is associated with a user ID included in the group G, and written in the group database 34.

The notification program 28 refers to the group database 34, and notifies each user terminal 100 operated by another user belonging to the same group G of information (for example, the set designation condition S, the profile P, the contact information, and the like) on other users belonging to the same group G.

For example, in a case where the first user, the second user, and the third user belong to the same group G, the first user terminal 100-1 is notified of information on the second user and the third user, the second user terminal 100-2 is notified of information on the first user, and information on the third user, and the third user terminal 100-3 is notified of information on the first user and the second user by the

### (Providing Connection Using Group Function)

The user combines the check-in registration function and the profile function in a state where the user logs in the connection providing system 10 from the user terminal 100 using, for example, the dedicated application and thus can realize the connection providing function using the group function as described below.

In this case, the condition designation program 23 designates, as the designation condition S, a place where each user wants to obtain a connection with another user, and a specific time zone are set and stored in the designation condition database 32.

In this state, for example, it is assumed that check-in registration is performed by the first user terminal 100-1 operated by the first user, and from the user terminal 100-1 to the connection providing system 10, the current location D (OX park), the arrival time (3:15 p.m.), and the user ID are transmitted.

The transmitted current location D (OX park), the arrival time (3:15 p.m.), and user ID are received by the communication unit 15 via the communication line 150, and output from the communication unit 15 to the memory 20.

The condition matching determination program 27 refers to the group database 34 and determines the group G to which the first user operating the user terminal 100-1 belongs from the user ID output from the communication unit 15. Further, using the user ID of the other users belonging to the group G, each designation condition S set by each user is acquired from a designation condition database 32. Then, it is determined whether the OX park which is the current location D output from the communication unit 15 and a time zone (for example, from 3:00 to 5:00 a.m.) including 3:15 p.m. of arrival time are set in each of the acquired designation conditions S.

The notification program 28 notifies the user terminal operated by the user who has set the designation condition S that is the positive determination by the condition matching determination program 27 of the OX park that is the current location D of the first user who operates the user terminal 100-1 and information (for example, a profile P and a contact address) related to the first user.

For example, in a case where the OX park are set in the designation condition S set by a second user and a time zone (for example, from 3:00 to 5:00 a.m.) including 3:15 a.m. which is an arrival time output from the communication unit 15 is set, the notification program 28 notifies the second user terminal 100-2 operated by a second user of the OX park which is the current location D of the first user and information on the first user.

Note that the designation condition S is not necessarily limited to setting a specific place. A wider area or the number of persons matching the condition is set instead of setting a specific place, and when users of the number matching the condition (for example, ten persons) visits the area, the notification program 28 can also notify information about all users visiting the area.

Next, an operation example of the connection providing system to which the connection providing method according to the embodiment of the present invention is applied will be described.

In the following description, description of the operations of user registration and user authentication is omitted, and an operation example when the connection providing system implements the check-in registration function, the profile function, and the group function without distinction will be described.

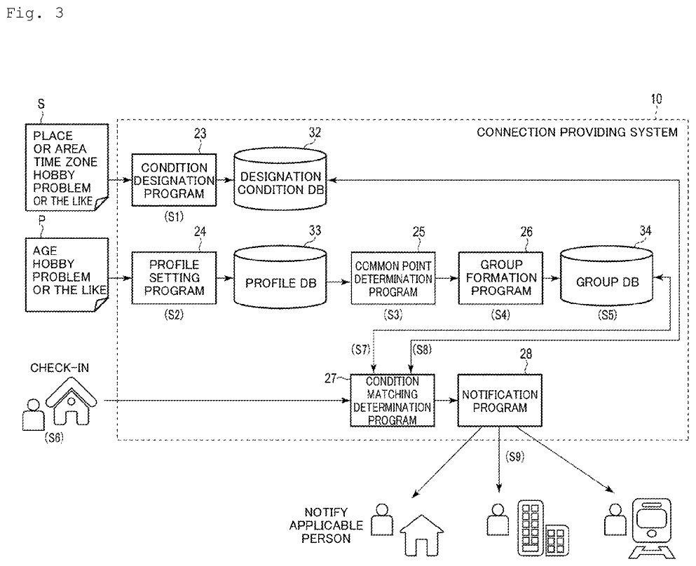

FIG. 3 is a diagram illustrating an operation example of the connection providing system to which a connection providing method according to the embodiment of the present invention is applied.

The user starts the condition designation program 23 in a state where the user logs in the connection providing system 10 from the user terminal 100, for example, using the dedicated application, and can set the designation condition S for obtaining a connection with other users.

As the designation condition S, the user can set the contents of arbitrary items such as place, area, specific time zone, hobbies, and problems.

The set designation condition S is written in the designation condition database 32 in association with the user ID of the user of the setting source by the condition designation program 23. Thus, the designation condition S of the user is set (S1).

In addition, the user uses, for example, the dedicated application, and the like, to start the profile setting program 24 in a state where the user logs in the connection providing system 10 from the user terminal 100, and can set the profile P itself.

The users can enter the contents of one or more arbitrary items such as age, hobbies, marital status, whether or not they have children and their ages, concerns, whether or not parents live together, living area, nearest station, favorite places, problems, or the like, as profile P.

The input profile P is written in the profile database 33 in association with the user ID by the profile setting program 24. Thus, the profile P of the user is set (S2).

In the common point determination program 25, the profile P of each user written in the profile database 33 is referred to, and a user having many common points in the content of the profile P is determined (S3).

In the group formation program 26, the group G composed of each user determined that there are many common points in the content of the profile P by the common point determination program 25 is formed (S4). The group ID unique to the group is given to the formed group G by the group formation program 26, the group ID is associated with the user ID included in the group G, and the group ID are written in the group database 34 (S5).

The check-in registration function is provided to the user terminal 100 in which the dedicated application is installed. Therefore, for example, in a case where the first user arrives at the OX park at 3:15 p.m. due to a walk, a travel or the like, with the check-in registration function, the user terminal 100-1 transmits the OX park being the current location D, 3:15 p.m. being the arrival time, and the user ID to the connection providing system 10 (S6).

The transmitted current location D (OX park), the arrival time (3:15 afternoon), and user ID are received by the communication unit 15 via the communication line 150, and output from the communication unit 15 to the memory 20.

In the condition matching determination program 27, the group database 34 is referred to, and the group G to which the first user belongs is determined from the user ID of the first user output from the communication unit 15 (S7). Further, each designation condition S set by a user other than the first user belonging to the group G is acquired from a designation condition database 32. Then, it is determined whether the OX park which is the current location D output from the communication unit 15 and a time zone including 3:15 p.m. which is the arrival time are set for each of the acquired designation conditions S (S8).

In a case where there is the designation condition S which is determined as affirmative by the condition matching determination program 27, the notification program 28 notifies the user terminal 100 operated by a user who has set the designation condition S of the OX park which is the current location D of the first user and information on the first user (for example, the profile P and the contact address) (S9).

For example, in a case where the OX park is set in the designation condition S set by the second user and the time zone (for example, from 3:00 to 5:00 p.m.) including 3:15 p.m. which is an arrival time output from the communication unit 15 is set, the notification program 28 notifies the second user terminal 100-2 operated by the second user of the OX park being the current location D of the first user and information (for example, the profile P and the contact address) related to the first user.

Thus, the second user can view the profile P set by the other users belonging to the same group, and if he/she wants to meet directly, he/she can contact and go to meet.

In this way, according to the connection providing system to which the connection providing method according to the embodiment of the present invention is applied, from among an unspecified number of individuals, it is possible to provide the user with information for promoting connection with people who are in the same situation, have the same worries, want to do the same things, or have similar philosophies.

Since the user can utilize the provided information to create a connection with a new person, even when the surrounding environment is suddenly changed, a new personal connection can be formed in the living zone in a new environment.

In this way, the connection providing system to which the connection providing method according to the embodiment of the present invention is applied can reduce the number of people who are isolated from the society and are worried about loneliness, and contribute to the formation of new personal interaction in a new environment.

Note that the processing of step S1, the processing of steps S2 to S5, and the processing of steps S6 to S9 shown in FIG. 3 can be performed independently or concurrently.

In addition, the methods described above can be stored as a program (software means) that can be executed by a calculator (computer), in a recording medium (storage medium) such as a magnetic disk (a floppy (registered trademark) disk, a hard disk, or the like), an optical disk (a CD-ROM, a DVD, a MO, or the like), a semiconductor memory (a ROM, a RAM, a Flash memory, or the like) or transmitted and distributed using a communication medium. Note that the program stored on the medium side includes a configuration program for configuring, in the computer, software means (including not only an execution program but also table and data structures) to be executed by the computer. The computer that realizes the above-mentioned connection providing system 10 reads the program recorded on the recording medium, constructs the software means by the setting program in some cases, and executes the above-described steps of processing by the software means controlling the operation. The recording medium referred to herein is not limited to a recording medium for distribution, and includes a storage medium such as a magnetic disk or a semiconductor memory provided inside the calculator or in a device connected via a network.

Note that the present invention is not limited to the embodiments described above and can variously be modified at an execution stage within a scope not departing from the gist of the present invention. Further, the foregoing embodiment include various inventions, and various inventions can be extracted by combinations selected from the plurality of components disclosed herein. For example, as long as the problem can be solved and the effects can be achieved even when several of the components described in the embodiment are removed, a configuration in which the components have been removed can be extracted as an invention.

Further, in the above embodiment, an example of the configuration in which the connection providing system 10 is realized by a single hardware has been described. However, the connection providing system 10 is not limited to a configuration realized by a single hardware, and can be implemented by combining a plurality of servers, that is, using one or more processors, and it is understood that such a configuration belongs to the technical scope of the present invention.

### REFERENCE SIGNS LIST

10 Connection providing system
11 Bus
12 CPU
13 External recording medium
14 Recording media reading unit
15 Communicating unit
20 Memory
21 User registration program
22 User authentication program
23 Condition designation program
24 Profile setting program
25 Common point determination program
26 Group formation program
27 Condition matching determination program
28 Notification program
29 Writable data area
30 Storage device
31 User registration information database
32 Designation condition database
33 Profile database
34 Group database
100 User terminal
150 Communication line

1. A connection providing system for providing information for promoting connection between a plurality of users via a communication line, the system comprising:
a designation unit, including one or more processors, configured to design a place where each of the plurality of users wants to obtain a connection with another user;
a determination unit, including one or more processors, configured to determine, when information indicating a current location is transmitted from a user terminal operated by any one of the plurality of users, whether the current location matches with a location designated by any one of the plurality of users; and
a notification unit, including one or more processors, configured to notify, in a case where affirmative determination is made by the determination unit, the user terminal of the user who has designated the matching place of the current location and information on the user who operates the user terminal that has transmitted the information indicating the current location.

2. A connection providing system for providing information for promoting connection between a plurality of users via a communication line, the system comprising:
a setting unit, including one or more processors, configured for each of the plurality of users to set their own profile;
a forming unit, including one or more processors, configured to form a group of users having many common points of the profiles; and
a notification unit, including one or more processors, configured to notify each user terminal operated by each user belonging to the same group of information on each user belonging to the formed same group.

3. A connection providing system for providing information for promoting connection between a plurality of users via a communication line, the system comprising:
a designation unit, including one or more processors, configured for each of the plurality of users to designate a place and a time zone;
a setting unit, including one or more processors, configured for each of the plurality of users to set their own profile;
a forming unit, including one or more processors, configured to form a group of users having many common points of the profiles;
a determination unit, including one or more processors, configured to determine, when information indicating a current location is transmitted from a user terminal operated by any user belonging to the formed same group, whether the current location and the time at which the current location is transmitted are included in a place and a time zone designated by any user belonging to the same group; and
a notification unit, including one or more processors, configured to notify, in a case where affirmative determination is made by the determination unit, a user terminal of a user who specifies the place and the time zone where the affirmative determination is made of the current location and information on the user who operates the user terminal that has transmitted the information indicating the current location.

4. The connection providing system according to claim 2, further comprising:
a first database for storing a profile set by the setting unit in association with identification information of a user of a setting source.

5. The connection providing system according to claim 2, wherein
the profile includes one or a plurality of items, the connection providing system further comprising:
a determination unit, including one or more processors, configured to determine a user having a common content of items of a predetermined proportion or more among the plurality of items as a user having many common points of the profile.

6. The connection providing system according to claim 1, further comprising:
a second database for storing the information designated by the designation unit in association with identification information of a user of a designation source.

7. (canceled)

8. (canceled)
